(19) United States
(12) Patent Application Publication
(10) Pub. No.: US 2023/0185522 A1
(43) Pub. Date: Jun. 15, 2023

(54) SYSTEMS, APPARATUS, AND METHODS FOR DATA ENTRY AT ELECTRONIC USER DEVICES

(71) Applicant: Shopify Inc., Ottawa (CA)

(72) Inventor: Daniel Crystal, Maple (CA)

(21) Appl. No.: 17/548,260

(22) Filed: Dec. 10, 2021

(51) Int. Cl. G06F 3/16; G07F 19/00; G06F 3/023; G06F 3/04842

(52) U.S. Cl. CPC G06F 3/167; G07F 19/206; G06F 3/165; G06F 3/0233; G06F 3/04842

(57) ABSTRACT

Systems, apparatus, and methods for data entry at electronic user devices are disclosed. An example apparatus includes at least one memory; instructions in the apparatus; and processor circuitry to execute the instructions to cause an electronic device to output an audio output corresponding to a first candidate character, the first candidate character random relative to a second candidate character, the first candidate character and the second candidate character representing potential inputs for a first value in a data entry field of an application of the electronic device; detect a first user selection of one of the first candidate character or the second candidate character; and in response to the first user selection, store the selected one of the first candidate character or the second candidate character in a buffer.

### FIELD OF THE DISCLOSURE

This disclosure relates generally to electronic user devices and, more particularly, to systems, apparatus, and methods for data entry at electronic user devices.

### BACKGROUND

A user interacting with an electronic user device such as an automated teller machine (ATM) may enter protected identification data (e.g., a pin, a password) at the device. In some instances, the user may provide the protected information via voice commands due to, for instance, a visual impairment or other disability that may make it difficult for the user to provide inputs via other input means such as typing.

### BRIEF DESCRIPTION OF THE DRAWINGS

FIG. 1 is a block diagram of an example e-commerce platform.

FIG. 2 is an illustration of an example home page of an administrator of the e-commerce platform of FIG. 1.

FIG. 3 illustrates an example system constructed in accordance with teachings of this disclosure and including an electronic user device and character control circuitry for providing data entry at the user device.

FIG. 4 is an example implementation of the character control circuitry of FIG. 3.

FIG. 5 illustrates an example graphical user interface for data entry in accordance with teachings of this disclosure.

FIG. 6 is a flowchart representative of example machine readable instructions that may be executed by example processor circuitry to implement the example character control circuitry of FIGS. 3 and/or 4.

FIG. 7 is a block diagram of an example processing platform including processor circuitry structured to execute the example machine readable instructions of FIG. 6 to implement the example character control circuitry of FIGS. 3 and/or 4.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIG. 6 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

A visual impairment or other disability may present difficulties for a user when interacting with electronic devices such as an automated teller machine (ATM) or point-of-sale device (e.g., credit card terminal) that request entry of protected identification data such as a pin or a password. Rather than entering the data at the device via, for instance, typing, the user may provide the protected identification data to the device via voice commands. However, such voice commands can compromise the integrity of the protected identification data due the risk of others overhearing the information.

Disclosed herein are example apparatus, systems, and methods that provide for audio outputs of characters (e.g., alphanumeric characters) via a private audio channel and accept an input command (e.g., a voice command) from the user to select a particular character for entry in a data entry field at an electronic device. The selected character(s) can correspond to the user's protected identification data (e.g., a pin, a password, a social security number) for entry in a data entry field of the device (e.g., the pin entry field of an ATM). The private audio channel can be established using, for example, headphones.

In examples disclosed herein, the audio outputs of the characters are provided in a random, non-predefined, or ad hoc order to minimize the risk of a timing attack. A timing attack may occur when values such as numbers are read out in a predictable order (e.g., 0 to 9) and an eavesdropper can determine which characters are being selected by the user by analyzing the timing of the user's confirmatory voice commands and/or based on keywords spoken by the user that can indicate the value of the characters. For instance, when digits are presented in order from 0 to 9 and the user speaks the word “next” three times before stating “accept,” an eavesdropper can guess that the user selected the digit “3.”

The audio outputs of the respective characters can be presented at timed intervals. Additionally or alternatively, examples disclosed herein can detect user inputs to advance audio output of the characters. For example, the user can provide a voice command to cause the audio output to advance to the next character or to replay the audio output of a previously presented character. In some examples, the user can provide a touch screen input or gesture at the input device to control output of the characters. Examples disclosed herein detect user inputs (e.g., a voice command, a gesture) indicative of a selection of a character. In response to selection of a character for a particular value in a data entry field, examples disclosed herein automatically present characters for selection in a subsequent value in the data entry field until all values in the data entry field have been confirmed or responded to by the user.

Although integration with a commerce platform is not required, in some embodiments, the examples disclosed herein may be performed on or in association with a commerce platform such as an e-commerce platform. Therefore, an example of a commerce platform will be described.

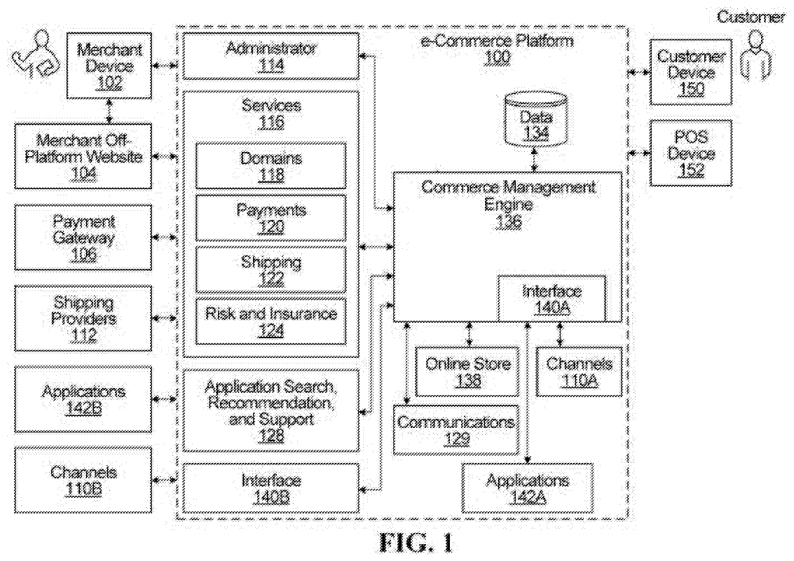

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility.

Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

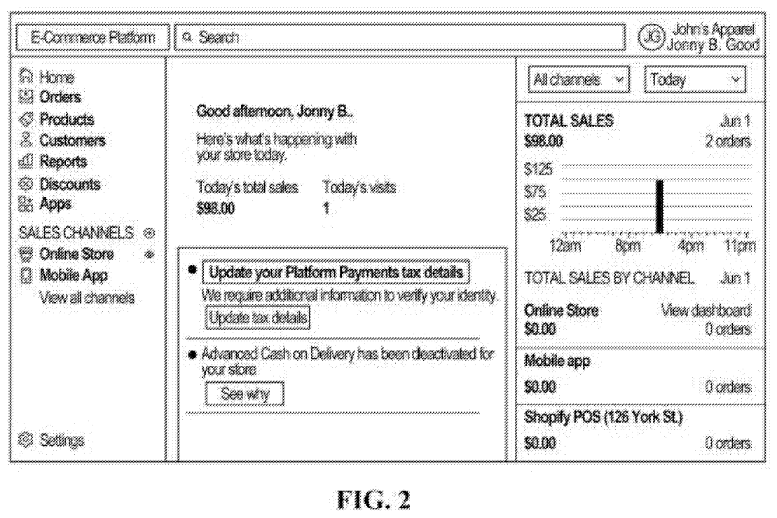

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

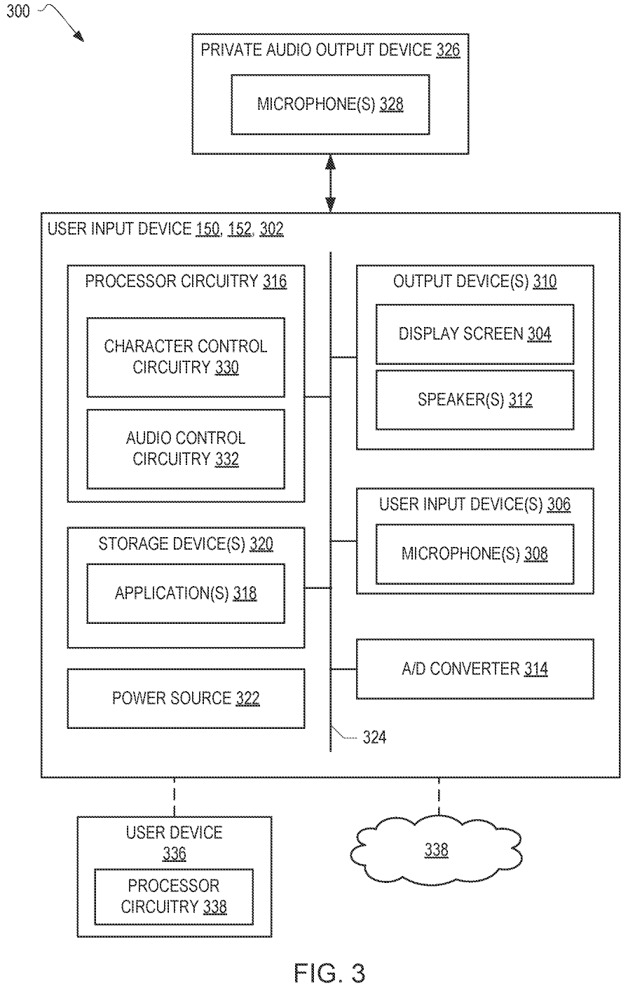

FIG. 3 illustrates an example system 300 constructed in accordance with teachings of this disclosure for data entry. The example system 300 of FIG. 3 includes an electronic user device 302 to enable a user to interface with a commerce platform such as the e-commerce platform 100 of FIG. 1. The user device 302 can include the customer device 150 of FIG. 1. For instance, the user device 302 can include a mobile computing device, a smartphone, etc. Additionally or alternatively, the user device 302 can include the POS device 152. In such examples, the user device 302 can include a retail device, a kiosk, automated (self-service) checkout system, etc. The user device 302 can include other types of user input devices such as an automated teller machine (ATM). In some examples, the user device 302 includes the merchant device 102 of FIG. 1.

The example user device 302 of FIG. 1 includes a display screen 304 to present graphical content to a user of the user device 102. In some examples, the display screen 304 is a touch screen that enables a user to interact with data presented on the display screen 304 by touching the display screen 304 with a stylus and/or one or more fingers or a hand of the user. Additionally or alternatively, the user can interact with data presented on the display screen 304 via user input device(s) 306 such as microphone(s) 308, a keyboard, a mouse, touch pad, etc. The example user device 102 includes one or more output device(s) 310 such as speaker(s) 312 to provide audible outputs to the user of the user device 302.

The example user device 302 includes the one or more microphone(s) 308. The microphone(s) 308 provide means for detecting sounds in the environment in which the user device 302 is located. The example user device 102 includes an analog-to-digital (A/D) converter 314 to convert analog signals from the microphone(s) 308 to digital signal(s).

The example user device 302 of FIG. 3 includes processor circuitry 316. The processor circuitry 316 of the example user device 302 is a semiconductor-based hardware logic device. The hardware processor circuitry 316 may implement, for instance, a central processing unit (CPU) of the user device 302. The processor circuitry 316 executes machine readable instructions (e.g., software) including, for example, application(s) 318 such as commerce application(s), financial application(s), etc. installed on the user device 302. For instance, the application(s) 318 can be used to facilitate payment via a credit card or debit card transaction; financial transactions such as the withdrawal of money from a personal banking account; verification of an identity of the user, etc. The user application(s) 318 are stored in one or more storage devices 320 such as non-volatile memory (e.g., flash memory). The example user device 302 of FIG. 1 includes a power source 322 such as a battery and/or transformer and AC/DC converter to provide power to the processor circuitry 316 and/or other components of the user device 302 communicatively coupled via a bus 324.

In the example of FIG. 3, the user device 302 is communicatively coupled to a private audio output device 326. The private audio output device 326 can include, for instance, headphones. The private audio output device 326 can be communicatively coupled to the user device 302 via wired or wireless communication protocols. For instance, the private audio output device 326 can include headphones that are coupled to a headphone output jack of the user device 302. In other examples, the private audio output device 326 includes wireless headphones that are communicatively coupled to the user device 302 via, for instance, Bluetooth® pairing. The communicative coupling between the private audio output device 326 and the user device 302 can be based on any present or future communication protocols. In some examples, the private audio output device 326 includes microphone(s) 328 to capture sound, such as a voice of the user wearing the private audio output device 326.

In the example of FIG. 3, a private audio channel is established when the private audio output device 326 is communicatively coupled to the user device 302. Put another way, audio output by the user device 302 is only or substantially only audible to a user of the private audio output device 326 when the private audio output device 326 is communicative coupled to the user device 302. For instance, sound associated with the application(s) 318 is output via the private audio output device 326 rather than the speaker(s) 312 of the user device 302.

In the example of FIG. 3, the application(s) 318 executed by the processor circuitry 316 can include one or more data entry fields to receive input(s) from the user. The data entry field(s) can be associated with protected identification information, such as a pin, a password, etc. The data entry field(s) can be presented via a graphical user interface displayed on the display screen 304 when the user is interacting with the application 318. Input(s) to the data entry field(s) can be provided via, for instance, touch input(s) on the display screen 304, via the user input device(s) 306 (e.g., keyboard inputs).

In some examples, a user (e.g., a visually impaired user) may select to operate the application 318 in an accessibility mode. When the accessibility mode is enabled, the application 318 may provide audio outputs (e.g., instructions) and/or enable the user to provide inputs to the data entry field(s) through, for instance, voice inputs. Additionally or alternatively, the accessibility mode can enable the user to enter, submit, or confirm inputs via gestures and/or touch inputs on the display screen 304 of the user device 302.

In the example of FIG. 3 character control circuitry 330 generates, identifies, or selects candidate characters for potential entry in the data entry field(s) and causes the candidate characters to be presented to the user as audio outputs via the private audio output device 326 to enable the user to select the candidate character(s). The character control circuitry 330 can provide the audio outputs of the characters when, for instance, the accessibility mode of the application 318 is enabled. The candidate characters can include possible entries for respective value(s) in the data entry field (e.g., the respective values or numbers of a pin, the respective values or letters of a password, etc.). The candidate characters can include numbers, letters, and/or symbols. In some examples, the characters are presented in a random order or ad hoc to prevent other individuals in the environment from identifying the characters. In some examples, the character control circuitry 330 generates a plurality of candidate characters for each value in the data entry field such that a set of characters is generated for each value (e.g., a first set of characters for a first value of a pin, a second set of characters for a second value of a pin).

In the example of FIG. 3, the character control circuitry 330 is implemented by executable instructions executed on the processor circuitry 316 of the user device 302. However, in other examples, character control circuitry 330 is implemented by processor circuitry 334 of another user device 336 (e.g., a smartphone, an edge device, a wearable device, etc.) in communication with the user device 302 (e.g., via wired or wireless communication protocols), and/or by a cloud-based device 338 (e.g., one or more server(s), processor(s), and/or virtual machine(s)). In other examples, the character control circuitry 330 is implemented by dedicated circuitry located on the user device 302 and/or the user device 336. These components may be implemented in software, hardware, or in any combination of two or more of software, firmware, and/or hardware.

In the example of FIG. 3, audio control circuitry 332 causes the candidate characters to be output via the private audio output device 326. In the example of FIG. 3, the audio control circuitry 332 is implemented by executable instructions executed on the processor circuitry 316 of the user device 302.

In response to the audio output of the candidate character(s), the user of the private audio output device 326 can select individual characters for entry in a respective value in the data entry field. In some examples, the user input is an audio input (i.e., a speech input) detected by the microphone(s) 308 of the user device 302 and/or the microphone(s) 328 of the private audio output device 326. In other examples, the user input can be provided as gesture or touch input on the display screen 304. In some examples, the user input(s) (e.g., speech inputs, touch input(s)) can include commands to cause the character control circuitry 330 to output additional candidate characters (e.g., to advance to the next character generated by the character control circuitry 330), to replay or provide audio output(s) of previously presented character(s), etc.

In response to selection of a character for a particular value in the data entry field, the character control circuitry 330 generates additional candidate characters to be presented with respect to a subsequent value in the data entry field (e.g., a second value in a pin number). In some examples, the character control circuitry 330 generates the candidate characters and/or sets of characters for output until the user indicates that all values have been entered (e.g., via a touch input on the display screen 304) or the character control circuitry 330 detects that all entries have been provided (e.g., based on instructions from the application(s) 318). The characters presented for each value of the data entry field can be output in random order to facilitate secure entry of data at the user device 302.

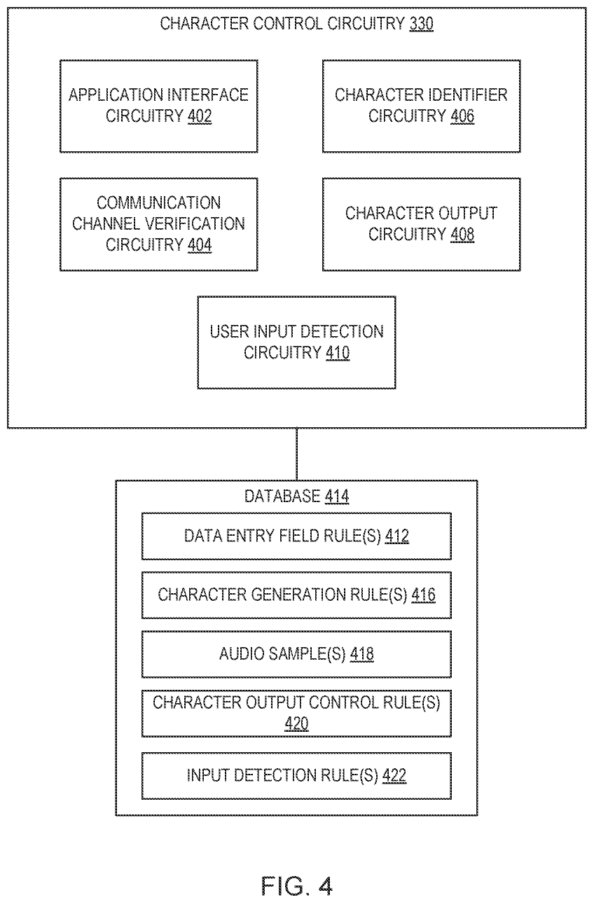

FIG. 4 is a block diagram of an example implementation of the character control circuitry 330 of FIG. 3. As mentioned above, the character control circuitry 330 is structured to generate candidate characters that represent possible or potential characters for entry in a data entry field of an application (e.g., an application 318 installed on the user device 302) and to respond to selection of character for entry in the field. The data entry field can include, for example, a password entry field, a pin entry field, etc. in connection with, for instance, a financial transaction at an ATM, a purchase on a point-of-sale device, etc. In the example of FIG. 4, the character control circuitry 330 is implemented by one or more of the processor circuitry 316 of the user device 302, the processor circuitry 334 of the second user device 336, and/or the cloud-based device(s) 338 (e.g., server(s), processors(s), and/or virtual machine(s) in the cloud 338 of FIG. 3 executing instructions). In some examples, some of the character control analysis is implemented by the character control circuitry 330 via a cloud-computing environment and one or more other parts of the analysis is implemented by the processor circuitry 316 of the user device 302 and/or the processor circuitry 334 of the user device 336 such as a wearable device. In some examples, the character control circuitry 330 is implemented by special purpose circuitry.

The example character control circuitry 330 of FIG. 4 includes application interface circuitry 402, communication channel verification circuitry 404, character identifier circuitry 406, character output circuitry 408, and user input detection circuitry 410.

In some examples, the application interface circuitry 402 receives instructions from an application 318 (FIG. 3) installed on the user device 302 that an accessibility mode for the application 318 has been enabled (e.g., based on a user input). In response to such instructions, the application interface circuitry 402 can cause the character identifier circuitry 406, the character output circuitry 408, and the user input detection circuitry 410 to be activated to provide candidate characters as audio outputs for selection as value(s) of a data entry field associated with the application 318 and to recognize selection of the character(s). In other examples, the application interface circuitry 402 receives instructions from the application 318 that the user has selected to receive the candidate characters as audio outputs based on, for instance, previous user preferences as defined in user profile information and with or without the accessibility mode being enabled.

In the example of FIG. 4, the communication channel verification circuitry 404 verifies that a private audio channel has been established between the user device 302 and the private audio output device 326. For instance, the communication channel verification circuitry 404 receives an indication from the audio control circuitry 332 (FIG. 3) confirming that a wired or wireless communicative coupling has been established between the user device 302 and the private audio output device 326. The communication channel verification circuitry 404 verifies that a private audio channel has been established in response to the indication of the communicative coupling between the user device 302 and the private audio output device 326. In some examples, the character control circuitry 330 is activated to provide character audio outputs in response to verification of the private audio channel by the communication channel verification circuitry 404 (i.e., without other input from the user and/or instructions from the application 318).

In the example of FIG. 4, the application interface circuitry 402 receives instructions or indications from the application 318 that a data entry field has been generated by the application 318 to receive user input(s). The instructions from the application 318 can include data entry field identification information indicative of the particular data entry field for which the input(s) are to be provided. For example, the instructions can indicate if the data entry field is a numeric pin field. If the communication channel verification circuitry 404 verifies that a private audio channel has been established, the character identifier circuitry 406 generates candidate character(s) to be presented as audio outputs for value(s) or input(s) in the data entry field.

The character identifier circuitry 406 identifies, generates, or otherwise determines the candidate character(s) based on one or more data entry field rules 412. The data entry field rule(s) 412 can define parameters of the respective data entry fields associated with the application 318. The parameters can include, for example, type(s) of characters associated with a particular data entry field. For instance, the data entry field rule(s) 412 can define whether the data entry field accepts letters and numbers, only numbers, particular symbols (e.g., a percentage sign but not an asterisk), etc. The data entry field rule(s) 412 can define the number of values to be received in the field (e.g., four values for pin entry at an ATM, six values for a password). The data entry field rule(s) 412 can be defined for a particular application 318 based on the data entry field(s) associated with the application 318. The data entry field rule(s) 412 are stored in a database 414. In some examples, the character control circuitry 330 includes the database 414. In other examples, the database 414 is located external to the character control circuitry 330 in a location accessible to the character control circuitry 330 as shown in FIG. 4.

In the example of FIG. 4, the character identifier circuitry 406 executes one or more character generation rule(s) 416 to generate, identity, or select the candidate characters to be output as audio outputs based on the parameters of the data entry field defined by the data entry field rule(s) 412. In some examples, the character generation rule(s) 416 can include algorithm(s) or model(s) (e.g., neural network models) for generating or selecting the candidate characters. As a result of execution of the character generation rule(s) 416, the character identifier circuitry 406 generates, identifies, or selects character(s) to be output as possible inputs in the data entry field.

In the example, of FIG. 4, the characters identified by the character identifier circuitry 406 as a result of execution of the character generation rule(s) 416 are generated in a random order (e.g., each character is in a random order relative to a previously selected or subsequently selected character). For example, the character identifier circuitry 406 can execute the character generation rule(s) 416 to randomly select a first number to be output for a first value in a numeric pin entry field, where the first number is different an expected starting number (i.e., not zero or one). For instance, the character identifier circuitry 406 can select the number “five” to be output as the first potential number for the first value in the numeric pin entry field as a result of execution of the character generation rule(s) 416. The character identifier circuitry 406 can determine that the number “nine” should be output as the second potential number for the first value in the numeric pin entry field to be presented after the first potential number (i.e., “five”) is presented. The character identifier circuitry 406 can determine that the number “three” should be output as the third potential number for the first value in the numeric pin entry field to be presented after the second potential number (i.e., “nine”) is presented based on execution of the character generation rule(s) 416. The character generation rule(s) 416 can include rules to prevent duplication of candidate characters for a particular value.

As a result of execution of the character generation rule(s) 416, the character identifier circuitry 406 generates a set of characters that represent possible inputs for the first value in the numeric pin entry field and are presented in a random or non-predefined order. In some examples, the character identifier circuitry 406 executes the rule(s) 416 to select or determine a character for output each time a character is to be generated (i.e., the characters to be output for a particular value in a data entry field are identified one at a time or ad hoc). In other examples, the character identifier circuitry 406 generates a set of characters in a random order as a result of execution of the rule(s) 416 (e.g., all possible characters for a value in a data entry field are identified at once). The character generation rule(s) 416 can be defined based on user inputs and stored in the database 414.

The character output circuitry 408 causes the character(s) that have been generated, selected, or otherwise identified by the character identifier circuitry 406 to be output as audio output(s) via the private audio channel. In some examples, the database 414 stores character audio samples 418 representing the characters (e.g., letters, numbers, symbols). The character audio samples 418 can be generated based on, for example, recorded speech and/or text-to-speech analysis. The character output circuitry 408 identifies the audio sample 418 corresponding to the character identified by the character identifier circuitry 406. The character output circuitry 408 generates instructions for the audio control circuitry 332 to output audio signal(s) corresponding to the selected audio sample 418. The audio control circuitry 332 causes the audio signal(s) to be transmitted for output via the private audio channel established with the private audio output device 326.

The character output circuitry 408 controls a rate at which the respective characters identified by the character identifier circuitry 406 are output as audio outputs based on character output control rule(s) 420. In some examples, the character output control rule(s) 420 define that the individual characters for a particular value in a data entry field should be output at predefined intervals of time (e.g., an audio output of a character every two seconds). In other examples, the character output control rule(s) 420 define that the characters should be output in response to an input (e.g., a voice command, a gesture) from the user indicating that the next character should be presented, as disclosed herein. The character output control rule(s) 420 can be defined based on user inputs and stored in the database 414.

The user input detection circuitry 410 detects inputs from the user in response to the audio outputs of the characters. In some examples, the user inputs include voice commands. The voice commands can include commands or requests for another character to be presented (e.g., a voice command such as “next”). The voice commands can include commands requesting output of a previously presented character (e.g., a voice command such as “back”). The voice commands can include commands to select a character for entry as a value in the data entry field after the presentation of a character (e.g., a voice command such as “select,” “yes,” “confirm”). Additional voice commands can be recognized by the user input detection circuitry 410, such as commands to delete a selection (e.g., a voice command such as “undo”). In some examples, the voice command includes a request for the character output circuitry 408 to cause audio of the selected character to be output and/or for audio outputs of all previously selected character inputs to be output to enable the user to confirm the selection(s) identified by the user input detection circuitry 410 are correct. The user input detection circuitry 410 interprets the audio signal(s) captured by the microphone(s) 328 of the private audio output device 326 and transmitted to the user device 302 and/or the audio signal(s) captured by the microphone(s) 308 of the user device 302 and processed by the audio control circuitry 332 based on input detection rule(s) 422. The input detection rule(s) 422 can define user inputs and corresponding responses by the character control circuitry 330. For example, the input detection rule(s) 422 can include models for audio input analysis (e.g., speech-to-text analysis), etc.

In other examples, the user inputs include touch inputs or gestures on the display screen 304 of the user device 302. For example, the user can provide a touch input to select a character in response to the audio output of the character, to request that another character be presented (e.g., to advance to the next character or to request that a previously presented character is presented again), to delete or undo a selection, etc. The user input detection circuitry 410 recognizes the touch input(s) provided by the user based on the input detection rule(s) 422.

As disclosed herein, in some examples, the character identifier circuitry 406 identifies characters for output and the character output circuitry 408 causes the characters to be output at timed intervals. In such examples, the character identifier circuitry 406 continues to generate the characters and the character output circuitry 408 causes the characters to be output as audio outputs until the user input detection circuitry 410 detects an input (e.g., a voice command, a touch input) indicating selection of a particular character.

In other examples, after generating and/or causing audio output of a character, the character identifier circuitry 406 waits to generate another character and/or the character output circuitry 408 refrains from causing output of another character until the user input detection circuitry 410 indicates that an input has been received for another character to be presented.

In other examples, the character output circuitry 408 causes the characters to be output at timed intervals, however, the character output circuitry 408 can cause a character to be presented before the timed interval in response to detection of a user command to advance to the next character by the user input detection circuitry 410.

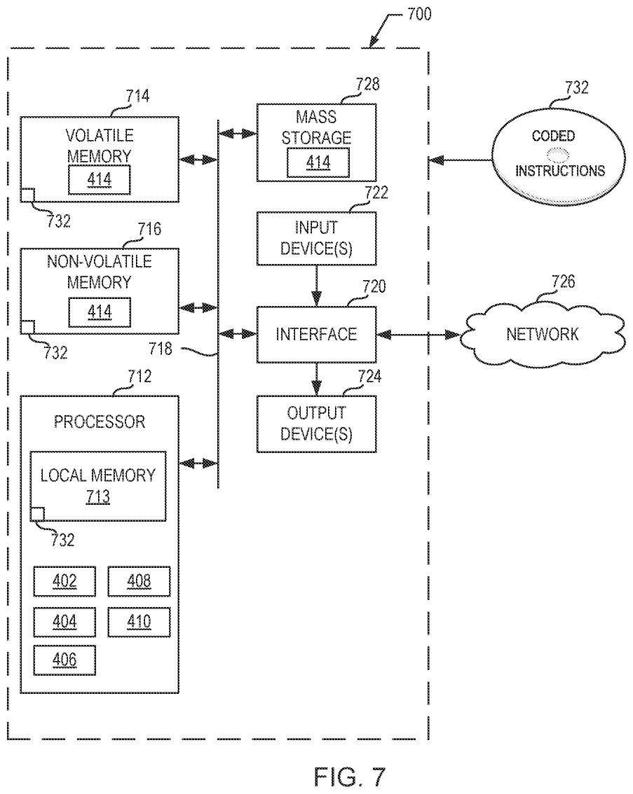

When the user input detection circuitry 410 recognizes a user input selecting a particular character (e.g., the most recent character provided as an audio output), the user input detection circuitry 410 can cause the value to be stored in, for example, a data buffer memory (e.g., a database buffer, the memory 714, 716 of the example processor platform 700 of FIG. 7). The application interface circuitry 402 can communicate with the application 318 to cause the application 318 to retrieve or access the value from the buffer as an input for a value in the data entry field.

For instance, the character identifier circuitry 406 can select or generate the numbers “5” and “6” for output as potential inputs for a first value in a data entry field. The character output circuitry 408 causes an audio output of the number “5” and an audio output of the number “6,” respectively. If the user input detection circuitry 410 determines that a user input of the number “6” has been confirmed or responded to by the user, the value of “6” can be stored in the buffer memory. In some examples, the application interface circuitry 402 communicates with the application 318 to cause the application 318 to recognize the value of “6” as the input for the first value in the data entry field. Also, as a result of the selection of the number “6” for the first value in the data entry field, the character identifier circuitry 406 refrains from generating further characters for the first value in the data entry field and/or the character output circuitry 408 refrains from causing further values from being output for the first value in the data entry field (e.g., in examples in which the character identifier circuitry 406 has generated a set of numbers to be output for the first value).

Also, in response to user selection of a character for a value in a data entry field, the character identifier circuitry 406 determines whether there are additional values in the data entry field for which a selection has not yet been responded to or confirmed based on the data entry field rule(s) 412. If there are additional values in the data entry field to be provided after a user input has been received, the character generator circuitry generates or selects new characters to be output as potential inputs for the additional values. For example, the character identifier circuitry 406 can execute the character generation rule(s) 412 to generate a new set of characters for a second value in the data entry field and the character output circuitry 408 causes audio outputs corresponding to the new set of characters to be presented until selection of a character is received for the second value. The character identifier circuitry 406 generates the characters (e.g., one at a time, as a set of characters) for output until the character identifier circuitry 406 determines that all values have been completed in the data entry field and/or the user indicates that all values have been entered (e.g., via a touch input, a voice command).

In some examples, the character generation rule(s) 412 includes rule(s) with respect to characters to be generated for subsequent values in the data entry field. For instance, the character generation rule(s) 412 can indicate that the first character output for a subsequent value in the data entry field should be the same character that was selected by the user for the previous value in the data entry field (e.g., if a value of “five” is selected for a first value in the data entry field, then the character identifier circuitry 406 will select the value of “five” to be presented as the first possible input for a second value in the data entry field). In other examples, the character generation rule(s) 412 can indicate that the first character output for a subsequent value in the data entry field should be random or different from the previous user input and/or from the first character output for the previous value in the data entry field (e.g., if a value of “five” is output as the first potential input and/or selected by the user for a first value in the data entry field, then the character identifier circuitry 406 will select a different value (e.g., “one”) to be presented as the first possible input for a second value in the data entry field). In other examples, the character generation rule(s) 412 define one or more values to be presented as possible inputs and/or an order in which the values are to be presented based on user preference inputs.

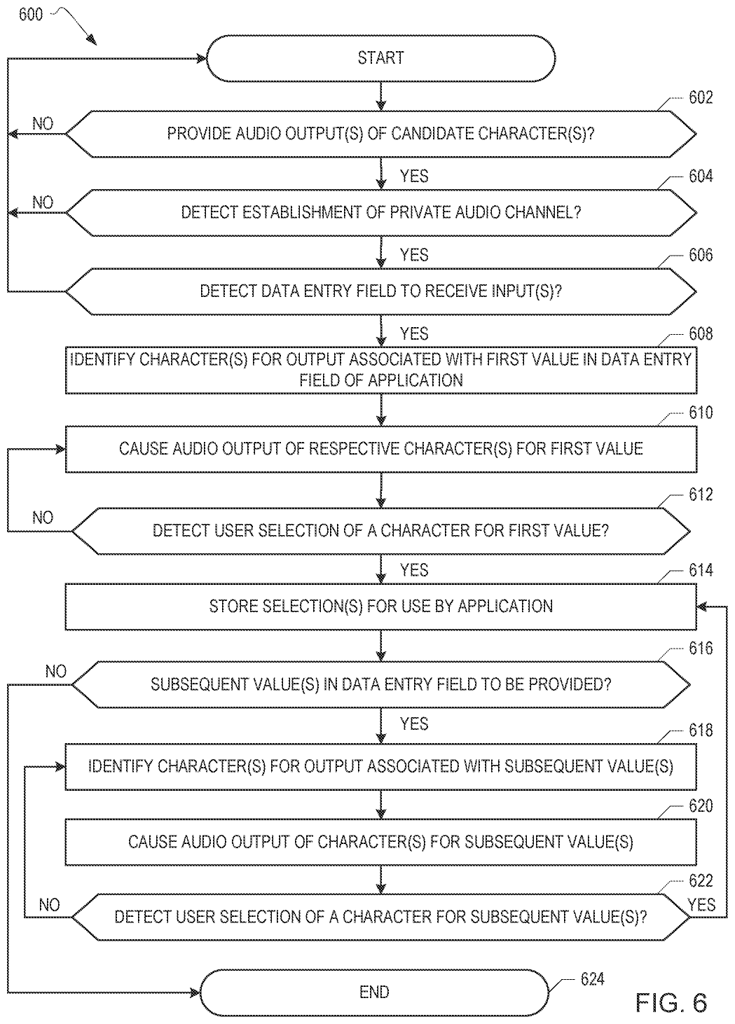

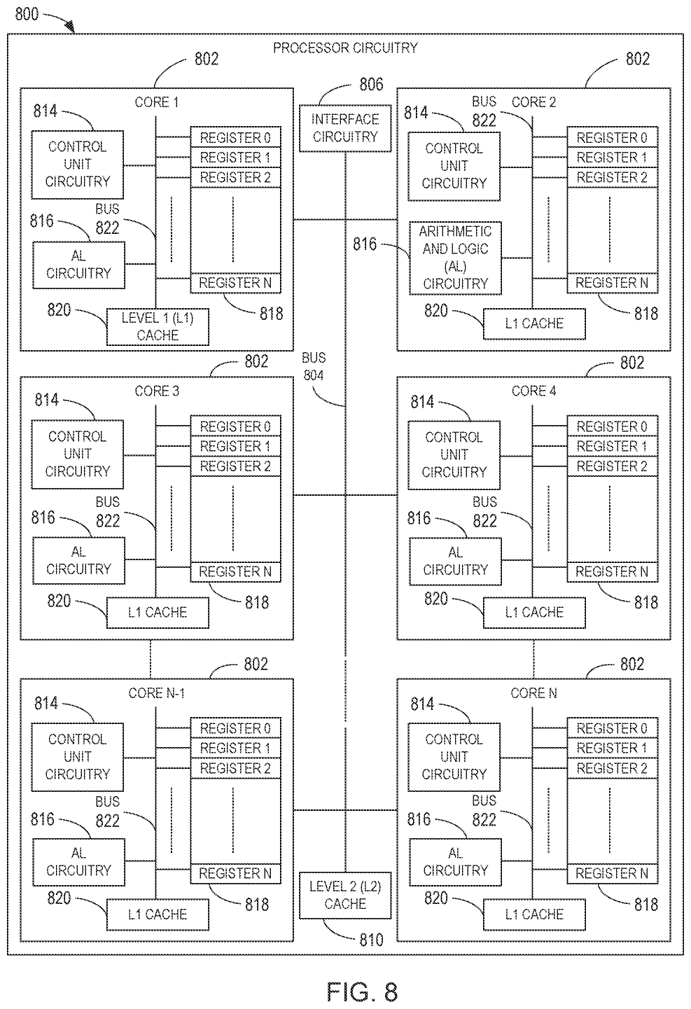

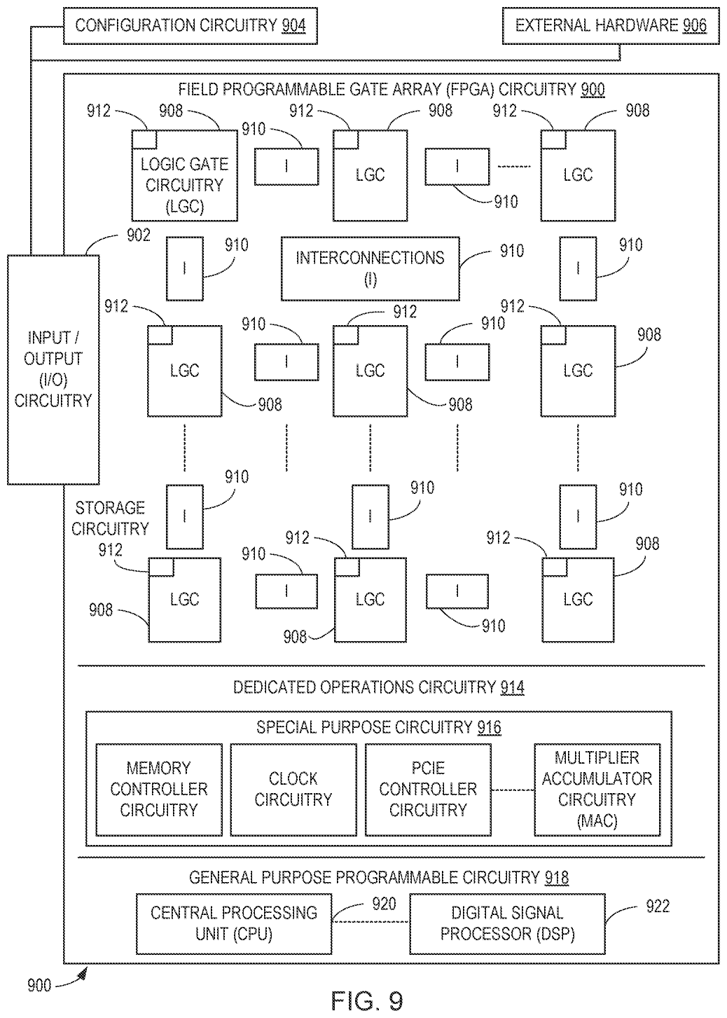

In some examples, the example system 300 of FIGS. 3 and/or 4 includes means for interfacing with an application. For example, the means for interfacing may be implemented by the application interface circuitry 402. In some examples, the application interface circuitry 402 may be implemented by machine executable instructions such as that implemented by at least blocks 602, 606 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the application interface circuitry 402 is implemented by other hardware logic circuitry, hardware implemented state machines, and/or any other combination of hardware, software, and/or firmware. For example, the application interface circuitry 402 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example system 300 of FIGS. 3 and/or 4 includes means for verifying an audio communication channel. For example, the means for verifying may be implemented by the communication channel verification circuitry 404. In some examples, the communication channel verification circuitry 404 may be implemented by machine executable instructions such as that implemented by at least blocks 604 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the communication channel verification circuitry 404 is implemented by other hardware logic circuitry, hardware implemented state machines, and/or any other combination of hardware, software, and/or firmware. For example, the communication channel verification circuitry 404 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example system 300 of FIGS. 3 and/or 4 includes means for identifying characters. For example, the means for identifying may be implemented by the character identifier circuitry 406. In some examples, the character identifier circuitry 406 may be implemented by machine executable instructions such as that implemented by at least blocks 608, 618 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the character identifier circuitry 406 is implemented by other hardware logic circuitry, hardware implemented state machines, and/or any other combination of hardware, software, and/or firmware. For example, the character identifier circuitry 406 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example system 300 of FIGS. 3 and/or 4 includes means for outputting characters. For example, the means for outputting may be implemented by the character output circuitry 408. In some examples, the character output circuitry 408 may be implemented by machine executable instructions such as that implemented by at least blocks 610, 620 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the character output circuitry 408 is implemented by other hardware logic circuitry, hardware implemented state machines, and/or any other combination of hardware, software, and/or firmware. For example, the character output circuitry 408 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the example system 300 of FIGS. 3 and/or 4 includes means for detecting user inputs. For example, the means for detecting may be implemented by the user input detection circuitry 410. In some examples, the user input detection circuitry 410 may be implemented by machine executable instructions such as that implemented by at least blocks 612, 614, 622 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the character output circuitry 408 is implemented by other hardware logic circuitry, hardware implemented state machines, and/or any other combination of hardware, software, and/or firmware. For example, the user input detection circuitry 410 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the character control circuitry 330 of FIG. 3 is illustrated in FIG. 4, one or more of the elements, processes, and/or devices illustrated in FIG. 4 may be combined, divided, re-arranged, omitted, eliminated, and/or implemented in any other way. Further, the example application interface circuitry 402, the example communication channel verification circuitry 404, the example character identifier circuitry 406, the example character output circuitry 408, the example user input detection circuitry 410, the example database 414 and/or, more generally, the example character control circuitry 330 of FIG. 4 may be implemented hardware alone or by hardware in combination with software and/or firmware. Thus, for example, any of the example application interface circuitry 402, the example communication channel verification circuitry 404, the example character identifier circuitry 406, the example character output circuitry 408, the example user input detection circuitry 410, the example database 414 and/or, more generally, the example character control circuitry 330 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example character control circuitry 330 of FIG. 3 may include one or more elements, processes, and/or devices in addition to, or instead of, those illustrated in FIG. 4, and/or may include more than one of any or all of the illustrated elements, processes, and devices.

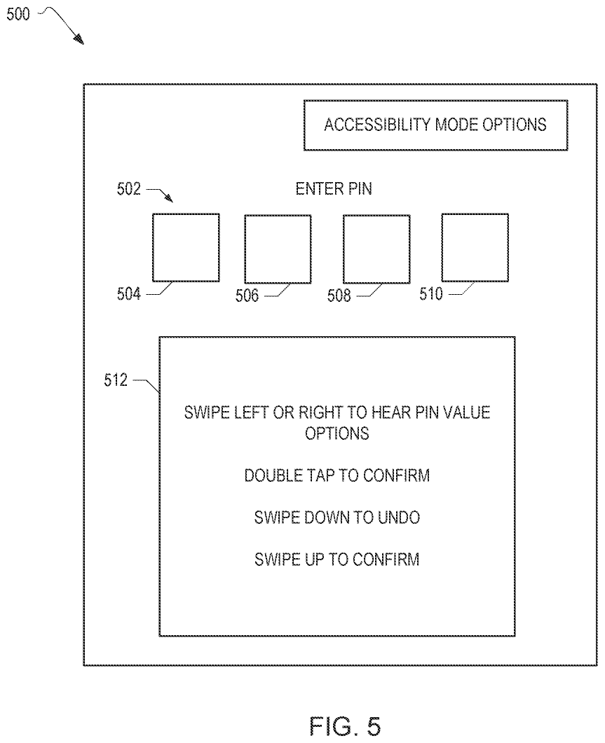

FIG. 5 illustrates an example graphical user interface 500 of an application (e.g., the application 318 of FIG. 3) operating an accessibility mode. The interface 500 can be displayed via, for instance, the display screen 304 of the user device 302. The accessibility mode can be accessed via user input selection(s) in the application (e.g., a menu selection). The interface 500 includes a data entry field 502 having a first value 504, a second value 506, a third value 508, and a fourth value 510. In the example of FIG. 5, the data entry field 502 is a numeric pin entry field. However, the data entry field 502 can include other types of fields, such as a password field that accepts letters, numbers, and/or symbols; include additional or fewer values, etc.

The example interface 500 can be displayed in connection with the audio output(s) provided by the character control circuitry 330 of FIGS. 3 and/or 4. For example, when the accessibility mode of the application associated with the interface 500 is enabled, the character identifier circuitry 406 of FIG. 4 identifies character(s) for potential values in the first value 504 of the data entry field 502. The character output circuitry 408 of FIG. 4 causes audio outputs of the candidate characters for entry in the first value 504 of the data entry field 502 to be provided (e.g., via the private audio output device 326 of FIG. 3). A user can select one of the characters for the first value 504 by providing a voice command input and/or by confirming selection via touch inputs or gestures relative to the interface 500. For example, the interface 500 can respond to touch input commands 512 such as double tapping to select a character (e.g., the most recent audio output), swiping right to cause the next character to be presented as an audio output, swiping left to cause a previous character to be presented as an audio output (e.g., replayed), swiping down to undo a selection, etc.

After selection of a character for the first value 504 of the data entry field 502, the character control circuitry 330 of FIGS. 3 and/or 4 generates characters to be output for the second value 506 of the data entry field 502. In the example of FIG. 5, the character control circuitry 330 generates and causes audio output of possible character inputs for each of the respective values 504, 506, 508, 510 in the data entry field 502 until characters for each of the respective values 504, 506, 508 have been responded to or confirmed by the user. In some examples, the user can provide a voice input or touch input command (e.g., swiping up) to indicate that selections for all values 504, 506, 508, 510 of the data entry field 502 have been confirmed.

A flowchart representative of example hardware logic circuitry, machine readable instructions, hardware implemented state machines, and/or any combination thereof for implementing the character control circuitry 330 of FIGS. 3 and/or 4 is shown in FIG. 6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 6, many other methods of implementing the example character control circuitry 330 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to provide audio outputs of potential character inputs for entry in a data entry field (e.g., a pin field, a password field) of a user application (e.g., the application 318 of FIG. 3) installed on a user device (e.g., the user device 302 of FIG. 3, such as a customer device or a point of sale device). The machine readable instructions and/or operations 600 of FIG. 6 begin at block 602 in which the application interface circuitry 402 of FIG. 4 determines whether audio outputs of the candidate characters should be provided in response to, for instance, user selection of a mode (e.g., an accessibility mode) of the application 318 indicating that audio outputs of the characters should be provided.

At block 604, the communication channel verification circuitry 404 detects or verifies that a private audio channel has been established between the user device including the application and a private audio output device 326 (e.g., headphones).

At block 606, the application interface circuitry 402 detects a data entry field (e.g., the data entry field 502 of FIG. 5) of the application 318 to receive input(s). The application interface circuitry 606 can detect the data entry field based on, for example, instructions from the application 318 indicating that a data entry field has been selected or presented to receive input(s).

At block 608, the character identifier circuitry 406 identifies character(s) to be presented as audio output(s), where the character(s) represent possible inputs for a first value of the data entry field (e.g., the first value 504 of the data entry field 502 of FIG. 5). The character identifier circuitry 406 can identify the character(s) based on the character generation rule(s) 412 and properties of the data entry field as defined by the data entry field rule(s) 412. In some examples, the character identifier circuitry 406 generates the characters one at a time. In other examples, the character identifier circuitry 406 generates a set of characters (i.e., multiple characters at once) for the first value of the data entry field as a result of execution of the character generation rule(s) 412. In the example of FIG. 6, the character identified by character identifier circuitry 406 are in random, ad hoc, or non-predefined order. Put another way, the characters are not generated by the character identifier circuitry 406 in a particular order (e.g., instead of selecting letters to be output as “A,” “B,” “C”, the character identifier circuitry 406 selects the characters to be output as “M,” “D,” “S”).

At block 610, the character output circuitry 408 causes the character(s) identified by the character identifier circuitry 406 for the first value in the data entry field to be output as audio outputs via the private audio channel. For example, the character output circuitry 408 identifies audio sample(s) 418 (e.g., text-to-speech samples, audio recordings) corresponding to the character(s) and causes the audio sample(s) 418 to be output via the audio control circuitry 332 of the user device 302. The character output circuitry 408 can cause the characters to be output at timed intervals (e.g., every two seconds) and/or in response to user commands (e.g., a voice or touch command to advance to the next character).

At block 612, the user input detection circuitry 410 determines if a user selection of a character has been confirmed for the first value of the data entry field. If the user input detection circuitry 410 recognizes a selection, at block 614, the user input detection circuitry 410 stores the selection in a memory buffer for access by the application 318. The user selection can be provided as, for instance, a voice command and/or a gesture and/or touch input at the user device 302 (e.g., the touch input commands 512 for the interface 500 of FIG. 5). If a user input corresponding to selection of one of the characters has not been detected by the user input detection circuitry 410, the character identifier circuitry 406 continues to identify character(s) for output (e.g., if a set of characters has not already been generated) and the character output circuitry 408 causes the character(s) to be output as audio outputs until a user selection is confirmed.

If the user input detection circuitry 410 detects an input corresponding to selection of a character input for the first value in the data entry field, at block 616 the character identifier circuitry 406 determines if there are additional values in the data entry field for which inputs are to be provided (the second, third, fourth values 504, 506, 508 of the data entry field 502) based on the data entry field rule(s) 412.

If there are additional values in the data entry field for which values are to be provided, the character identifier circuitry 406 generates characters to be output for a subsequent value in the data entry field at block 618. For example, the character identifier circuitry 406 can generate a new set of characters for a second value in the data entry field (e.g., the second value 506 of the data entry field 502 of FIG. 5), where the second set of characters is in a random order and a different order than the characters generated for the first value in the data entry field.

At block 620, the character output circuitry 408 causes output of the character(s) for the subsequent value in the data entry field. At block 622, the user input detection circuitry 410 identifies user responses or inputs corresponding to respective selections of one of the characters for entry in the corresponding subsequent values of the data entry field.

The character identifier circuitry 406 continues to generate the characters and the character output circuitry 408 cause the characters to be output as audio outputs via the private audio channel until an indication that there no further values in the data entry field for which inputs are to be provided. The indication can be received via user input (e.g., conformation that all values are complete) or detected by the character identifier circuitry 406 based on the data entry field rule(s) 412. When there are no further values in the data entry field for which inputs are to be provided, the instructions 600 of FIG. 6 end at block 624.

FIG. 7 is a block diagram of an example processor platform 700 structured to execute and/or instantiate the machine readable instructions and/or operations of FIG. 6 to implement the character control circuitry 330 of FIGS. 3 and/or 4. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example application interface circuitry 402, the example communication channel verification circuitry 404, the example character identifier circuitry 406, the example character output circuitry 408, and the example user input detection circuitry 410.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 732, which may be implemented by the machine readable instructions of FIG. 6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 6.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 820 may implement at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowchart of FIG. 6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowchart of FIG. 6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowchart of FIG. 6. As such, the FPGA circuitry 900 may be structured to effectively instantiate some or all of the machine readable instructions of the flowchart of FIG. 6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor 800 of FIG. 8. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIG. 6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowchart of FIG. 6 may be executed by one or more of the cores 802 of FIG. 8 and a second portion of the machine readable instructions represented by the flowchart of FIG. 6 may be executed by the FPGA circuitry 900 of FIG. 9.

In some examples, the processor circuitry 712 of FIG. 7 may be in one or more packages. For example, the processor circuitry 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

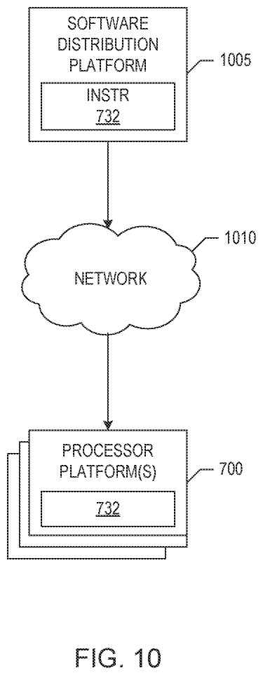

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions 600 of FIG. 6, as described above. The one or more servers of the example software distribution platform 1005 are in communication with a network 1010, which may correspond to any one or more of the Internet and/or any of the example networks 726 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions 732 of FIG. 7, may be downloaded to the example processor platform 700, which is to execute the machine readable instructions 732 to implement the character control circuitry 330. In some example, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that provide for audio outputs representing possible character inputs for a data entry field of a user application via a private audio channel. In particular, examples disclosed herein provide the character audio inputs in a random order to protect the integrity of the information entered into the data entry field from, for instance, eavesdroppers who may otherwise guess the values of the user inputs. Examples disclosed herein generate or select characters to be output based on properties of the data entry field. Disclosed examples cause audio outputs corresponding to the characters to be provided via the private audio channel (e.g., headphones) and recognize user inputs indicating selection of one of the characters for entry in the field. Examples disclosed herein provide for secure entry of data via voice commands through random or non-predefined presentation of potential character inputs for the data entry field.

Example methods, apparatus, systems, and articles of manufacture for data entry at electronic user devices are disclosed herein. Further examples and combinations thereof include the following:

Example 1 includes an apparatus comprising at least one memory; instructions in the apparatus; and processor circuitry to execute the instructions to cause an electronic device to output an audio output corresponding to a first candidate character, the first candidate character random relative to a second candidate character, the first candidate character and the second candidate character representing potential inputs for a first value in a data entry field of an application of the electronic device; detect a first user selection of one of the first candidate character or the second candidate character; and in response to the first user selection, store the selected one of the first candidate character or the second candidate character in a buffer.

Example 2 includes the apparatus of example 1, wherein the first user selection includes a touch input on a display screen of the electronic device or a voice command.

Example 3 includes the apparatus of examples 1 or 2, wherein the processor circuitry is to in response to the first user selection, identify a third candidate character and a fourth candidate character, the third candidate character and the fourth candidate character representing potential inputs for a second value in the data entry field; and cause the electronic device to output respective audio outputs corresponding to the third candidate character and the fourth candidate character.

Example 4 includes the apparatus of any of examples 1-3, wherein the third candidate character is random relative to the fourth candidate character.

Example 5 includes the apparatus of any of examples 1-4, wherein the first candidate character and the second candidate character define a first set of characters and the third candidate character and the fourth candidate character define a second set of characters, the first set of characters associated with a first random order and the second set of characters associated with a second random order, the second random order different from the first random order.

Example 6 includes the apparatus of any of examples 1-5, wherein the audio output is a first audio output and the processor circuitry is to cause the electronic device to output the first audio output at a first time; and cause the electronic device to output a second audio output of the second candidate character at a second time, the second time occurring after a time threshold relative to the first time.

Example 7 includes the apparatus of any of examples 1-6, wherein the audio output is a first audio output and the processor circuitry is to cause the electronic device to output a second audio output corresponding to the second candidate character prior to the first audio output; detect a second user selection, the second user selection associated with a request for an additional candidate character to be presented; and cause the electronic device to output the first audio output in response to the second user selection.

Example 8 includes the apparatus of any of examples 1-7, wherein the processor circuitry is to detect a communicative coupling between the electronic device and a private audio output device; and cause the electronic device to output the audio output in response to the communicative coupling.

Example 9 includes a non-transitory computer readable storage medium comprising instructions that, when executed, cause at least one processor to at least cause an audio output corresponding to a first candidate character to be presented, the first candidate character random relative to a second candidate character, the first candidate character and the second candidate character representing potential inputs for a first value in a data entry field of an application of an electronic device; detect a first user selection of one of the first candidate character or the second candidate character; and in response to the first user selection, store the selected one of the first candidate character or the second candidate character in a buffer.

Example 10 includes the non-transitory computer readable storage medium of example 9, wherein the first user selection includes a voice command or a touch input on a display screen of the electronic device.

Example 11 includes the non-transitory computer readable storage medium of examples 9 and 10, wherein the instructions, when executed, cause the at least one processor to in response to the first user selection, identify a third candidate character and a fourth candidate character, the third candidate character and the fourth candidate character representing potential inputs for a second value in the data entry field; and cause respective audio outputs of the third candidate character and the fourth candidate character to be presented.

Example 12 includes the non-transitory computer readable storage medium of any of examples 9-11, wherein the third candidate character is random relative to the fourth candidate character.

Example 13 includes the non-transitory computer readable storage medium of any of examples 9-12, wherein the first candidate character and the second candidate character define a first set of characters and the third candidate character and the fourth candidate character define a second set of characters, the first set of characters associated with a first random order and the second set of characters associated with a second random order, the second random order different from the first random order.

Example 14 includes the non-transitory computer readable storage medium of any of examples 9-13, wherein the audio output is a first audio output and the instructions, when executed, cause the at least one processor to cause the first audio output to be presented at a first time; and cause a second audio output corresponding to the second candidate character to be presented at a second time, the second time occurring after a time threshold relative to the first time.

Example 15 includes the non-transitory computer readable storage medium of any of examples 9-14, wherein the audio output is a first audio output and the instructions, when executed, cause the at least one processor to cause a second audio output corresponding to the second candidate character to be presented prior to the first audio output; detect a second user selection, the second user selection associated with a request for an additional candidate character to be presented; and cause the first audio output to be presented in response to the second user selection.

Example 16 includes the non-transitory computer readable storage medium of any of examples 9-15, wherein the instructions, when executed, cause the at least one processor to detect establishment of a private audio channel; and cause the audio output to be presented in response to the establishment of the private audio channel.

Example 17 includes a method comprising causing an electronic device to output an audio output corresponding to a first candidate character, the first candidate character random relative to a second candidate character, the first candidate character and the second candidate character representing potential inputs for a first value in a data entry field of an application of the electronic device; recognizing a first user input of one of the first candidate character or the second candidate character; and in response to the first user input, storing the selected one of the first candidate character or the second candidate character in a buffer.

Example 18 includes the method of example 17, further including detecting a communicative coupling between the electronic device and a private audio output device; and causing the electronic device to output the audio output in response to the communicative coupling.

Example 19 includes the method of examples 17 or 18, wherein the audio output is a first audio output and further including causing the first audio output to be presented at a first time; and causing a second audio output corresponding to the second candidate character to be presented at a second time in response to one of a second user input or expiration of a time threshold.

Example 20 includes the method of any of examples 17-19, further including, in response to the first user input, selecting a third candidate character and a fourth candidate character, the third candidate character and the fourth candidate character representing potential inputs for a second value in the data entry field; and causing the electronic device to output respective audio outputs of the third candidate character and the fourth candidate character.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

The status of the claims:

1. An apparatus comprising:
at least one memory;
machine-readable instruction; and
processor circuitry to execute the machine-readable instructions to at least:
generate a first candidate character representing a potential input for a first value in a data entry field of an application of an electronic device;
cause the electronic device to output a first audio output corresponding to the first candidate character;
after causing the output of the first audio output, generate a second candidate character, the first candidate character different than the second candidate character, the second candidate character representing another potential input for the first value in the data entry field;
cause the electronic device to output a second audio output corresponding to the second candidate character;
detect a first user selection of one of the first candidate character or the second candidate character; and
in response to the first user selection, store the selected one of the first candidate character or the second candidate character in a buffer.

2. The apparatus of claim 1, wherein the first user selection includes a touch input on a display screen of the electronic device or a voice command.

3. The apparatus of claim 1, wherein the processor circuitry is to:
in response to the first user selection, identify a third candidate character and a fourth candidate character, the third candidate character and the fourth candidate character representing potential inputs for a second value in the data entry field; and
cause the electronic device to output respective audio outputs corresponding to the third candidate character and the fourth candidate character.

4. The apparatus of claim 3, wherein the third candidate character is different than the fourth candidate character.

5. The apparatus of claim 3, wherein the first candidate character and the second candidate character define a first set of characters and the third candidate character and the fourth candidate character define a second set of characters, the first set of characters associated with a first random order of characters and the second set of characters associated with a second random order of characters, the second random order of characters different from the first random order of characters.

6. The apparatus of claim 1, wherein the processor circuitry is to:
cause the electronic device to output the first audio output at a first time; and
cause the electronic device to output the second audio output at a second time, the second time occurring after a time threshold relative to the first time.

7. The apparatus of claim 1, wherein the processor circuitry is to:
cause the electronic device to output a third audio output corresponding to a third candidate character prior to the first audio output;
detect a second user selection, the second user selection associated with a request for an additional candidate character to be presented; and
cause the electronic device to output the first audio output in response to the second user selection.

8. The apparatus of claim 1, wherein the processor circuitry is to:
detect a communicative coupling between the electronic device and a private audio output device; and
cause the electronic device to output the first audio output in response to the detection of the communicative coupling.

9. A non-transitory computer readable storage medium comprising instructions that, when executed, cause processor circuitry to at least:
generate a first candidate character representing a potential input for a first value in a data entry field of an application of an electronic device;
cause a first audio output corresponding to the first candidate character to be presented;
after causing the output of the first audio output, generate a second candidate character, the first candidate character different than the second candidate character, the second candidate character representing another potential input for the first value in the data entry field;
cause a second audio output corresponding to the second candidate character to be presented;
detect a first user selection of one of the first candidate character or the second candidate character; and
in response to the first user selection, store the selected one of the first candidate character or the second candidate character in a buffer.

10. The non-transitory computer readable storage medium of claim 9, wherein the first user selection includes a voice command or a touch input on a display screen of the electronic device.

11. The non-transitory computer readable storage medium of claim 9, wherein the instructions, when executed, cause the processor circuitry to:
in response to the first user selection, identify a third candidate character and a fourth candidate character, the third candidate character and the fourth candidate character representing potential inputs for a second value in the data entry field; and
cause respective audio outputs of the third candidate character and the fourth candidate character to be presented.

12. The non-transitory computer readable storage medium of claim 11, wherein the third candidate character is different than the fourth candidate character.

13. The non-transitory computer readable storage medium of claim 11, wherein the first candidate character and the second candidate character define a first set of characters and the third candidate character and the fourth candidate character define a second set of characters, the first set of characters associated with a first random order of characters and the second set of characters associated with a second random order of characters, the second random order of characters different from the first random order of characters.

14. The non-transitory computer readable storage medium of claim 9, wherein the instructions, when executed, cause the processor circuitry to:
cause the first audio output to be presented at a first time; and
cause the second audio output to be presented at a second time, the second time occurring after a time threshold relative to the first time.

15. The non-transitory computer readable storage medium of claim 9, wherein the instructions, when executed, cause the processor circuitry to:
cause a third audio output corresponding to a third candidate character to be presented prior to the first audio output;
detect a second user selection, the second user selection associated with a request for an additional candidate character to be presented; and
cause the first audio output to be presented in response to the second user selection.

16. The non-transitory computer readable storage medium of claim 9, wherein the instructions, when executed, cause the processor circuitry to:
detect establishment of a private audio channel; and
cause the first audio output to be presented in response to the detection of the establishment of the private audio channel.

17. A method comprising:
generating a first candidate character representing a potential input for a first value in a data entry field of an application of an electronic device;
causing the electronic device to output a first audio output corresponding to the first candidate character;
after causing the output of the first audio output, generate a second candidate character, the first candidate character different than the second candidate character, the second candidate character representing another potential input for the first value in the data entry field;
cause the electronic device to output a second audio output corresponding to the second candidate character;
recognizing a first user input of one of the first candidate character or the second candidate character; and
in response to the first user input, storing the one of the first candidate character or the second candidate character corresponding to the first use input in a buffer.

18. The method of claim 17, further including:
detecting a communicative coupling between the electronic device and a private audio output device; and
causing the electronic device to output the first audio output in response to the detection of the communicative coupling.

19. The method of claim 17, further including:
causing the first audio output to be presented at a first time; and
causing the second audio output to be presented at a second time in response to one of a second user input or expiration of a time threshold.

20. The method of claim 17, further including:
in response to the first user input, selecting a third candidate character and a fourth candidate character, the third candidate character and the fourth candidate character representing potential inputs for a second value in the data entry field; and
causing the electronic device to output respective audio outputs of the third candidate character and the fourth candidate character.
